(19) United States
(12) Patent Application Publication
(10) Pub. No.: US 2012/0233809 A1
(43) Pub. Date: Sep. 20, 2012

(54) Castor Having A Shock Absorbing Function

(76) Inventor: Yu-Wen Lee, Yuanlin Town (TW)

(21) Appl. No.: 13/051,135

(22) Filed: Mar. 18, 2011

(51) Int. Cl. B60B 33/00

(52) U.S. Cl. 16/45; 16/18 R

(57) ABSTRACT

A castor includes an inner frame, an outer frame surrounding the inner frame, a plurality of buffering members mounted between the inner frame and the outer frame, a plurality of connecting ribs each connected between the outer frame and a respective one of the buffering members, and a plurality of connecting flanges each connected between the inner frame and a respective one of the buffering members. Thus, the buffering members are mounted between the inner frame and the outer frame and are compressed and deformed elastically to provide a shock absorbing and buffering effect to the castor when the castor is subjected to an external force or impact so as to reduce the vibration and pressure of the castor, thereby providing a comfortable sensation to a user when moving the castor.

### BACKGROUND OF THE INVENTION

1. Field of the Invention

The present invention relates to a castor and, more particularly, to a castor for a cart, a luggage carrier, a trolley and the like.

2. Description of the Related Art

A conventional castor 20 in accordance with the prior art shown in FIGS. 10 and 11 comprises an inner frame 22, an outer frame 21 surrounding the inner frame 22, and a plurality of support ribs 23 mounted between the inner frame 22 and the outer frame 21. Thus, the conventional castor 20 is available for a vehicle, such as a hand cart, a hand truck, a luggage carrier, a baby trolley and the like, so as to facilitate a user moving the vehicle. However, the support ribs 23 cannot provide a shock absorbing or buffering effect to the castor 20 when the castor 20 is subjected to an external force or impact, thereby providing an uncomfortable sensation to a user when moving the castor.

### BRIEF SUMMARY OF THE INVENTION

In accordance with the present invention, there is provided a castor, comprising an inner frame, an outer frame surrounding the inner frame, and a plurality of buffering members mounted between the inner frame and the outer frame. The castor further comprises a plurality of connecting ribs each connected between the outer frame and a respective one of the buffering members, and a plurality of connecting flanges each connected between the inner frame and a respective one of the buffering members. The castor has a receiving chamber defined between the inner frame and the outer frame to receive the buffering members. The receiving chamber has an annular shape. Each of the buffering members has an oblong shape. Each of the buffering members has a hollow inside provided with a buffering space.

The primary objective of the present invention is to provide a castor having a shock absorbing function.

According to the primary advantage of the present invention, the buffering members are mounted between the inner frame and the outer frame and are compressed and deformed elastically to provide a shock absorbing and buffering effect to the castor when the castor is subjected to an external force or impact so as to reduce the vibration and pressure of the castor, thereby providing a comfortable sensation to a user when moving the castor.

According to another advantage of the present invention, the buffering members provide a shock absorbing effect to the castor so that the castor is moved smoothly without producing noise during movement.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor in accordance with the preferred embodiment of the present invention.

FIG. 2 is an exploded perspective view of the castor as shown in FIG. 1.

FIG. 3 is a front view of the castor as shown in FIG. 1.

FIG. 4 is a side cross-sectional view of the castor taken along line 4-4 as shown in FIG. 3.

FIG. 5 is a schematic operational view of the castor as shown in FIG. 3 in use.

FIG. 6 is a front view of a castor in accordance with another preferred embodiment of the present invention.

FIG. 7 is a perspective view showing the castor is available for a hand cart or truck.

FIG. 8 is a perspective view showing the castor is available for a luggage carrier.

FIG. 9 is a perspective view showing the castor is available for a baby trolley.

FIG. 10 is a front view of a conventional castor in accordance with the prior art.

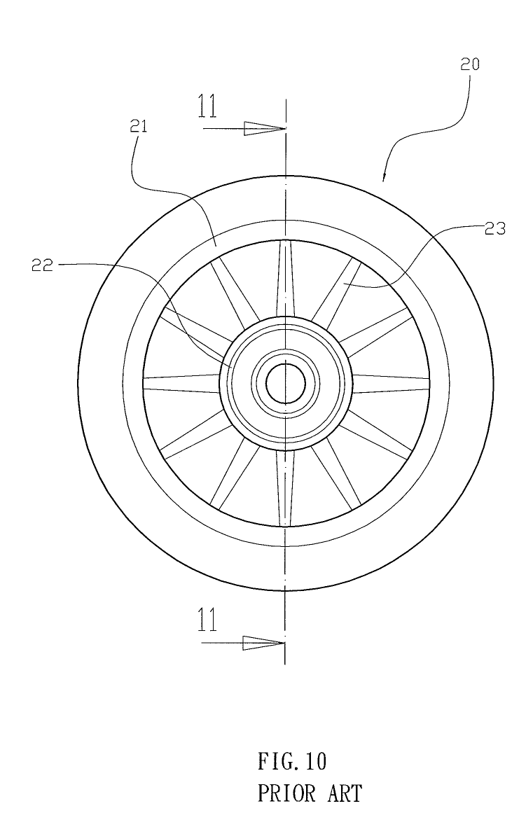

FIG. 11 is a side cross-sectional view of the conventional castor taken along line 11-11 as shown in FIG. 10.

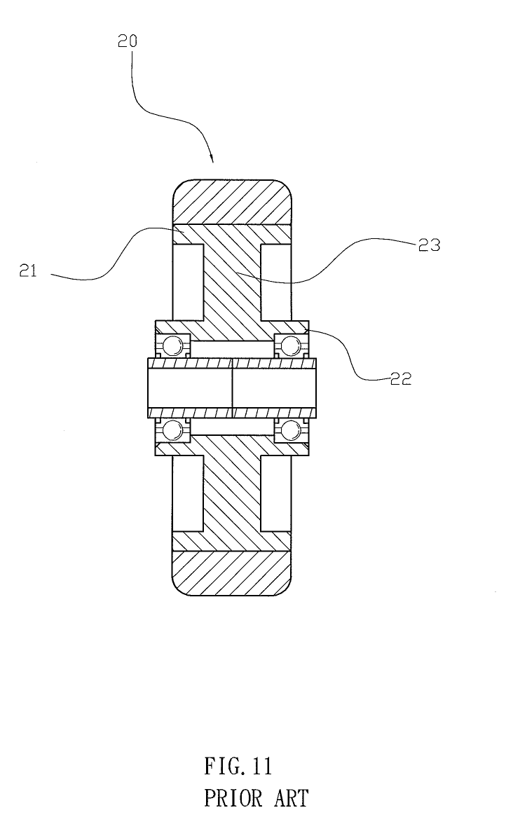

### DETAILED DESCRIPTION OF THE INVENTION

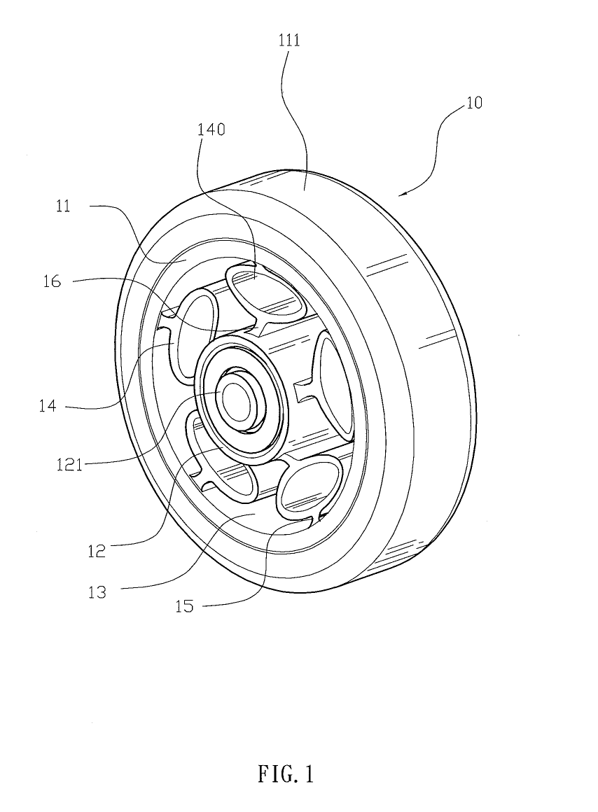

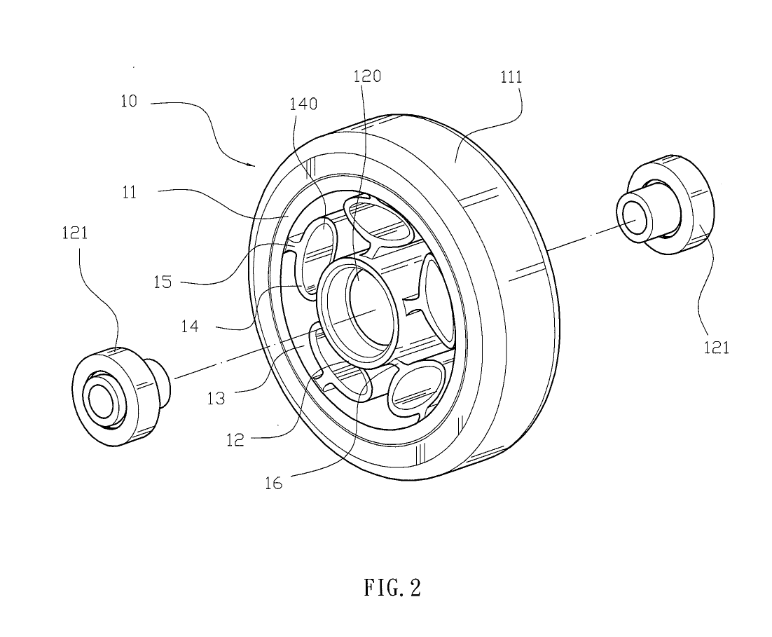

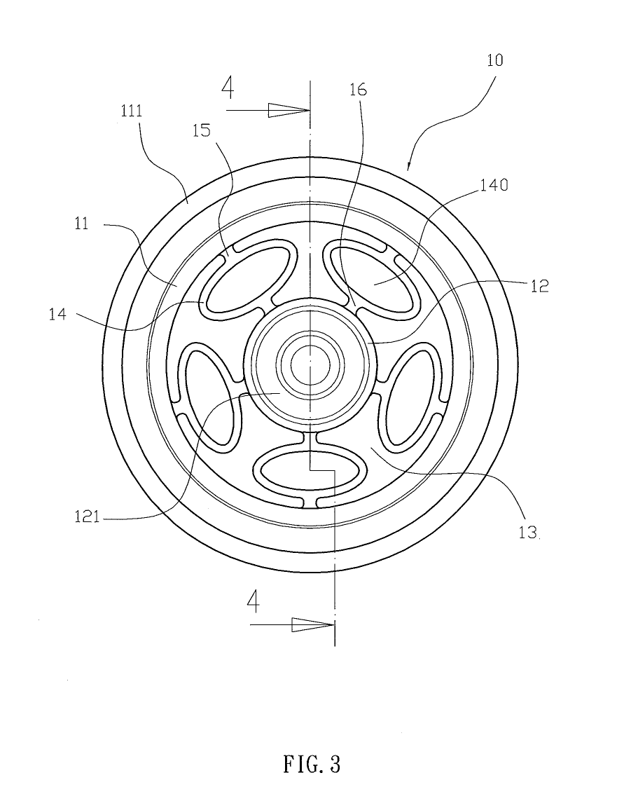

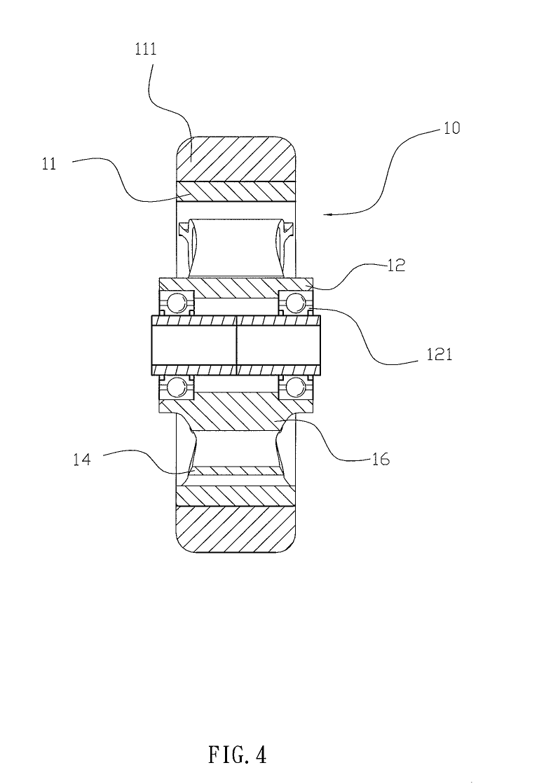

Referring to the drawings and initially to FIGS. 1-5, a castor 10 in accordance with the preferred embodiment of the present invention comprises an inner frame 12, an outer frame 11 surrounding the inner frame 12, a plurality of buffering members 14 mounted between the inner frame 12 and the outer frame 11, a plurality of connecting ribs 15 each connected between the outer frame 11 and a respective one of the buffering members 14, a plurality of connecting flanges 16 each connected between the inner frame 12 and a respective one of the buffering members 14, at least one bearing 121 mounted in the inner frame 12, and an outer tire 111 mounted on the outer frame 11.

The castor 10 has a receiving chamber 13 defined between the inner frame 12 and the outer frame 11 to receive the buffering members 14. The receiving chamber 13 has an annular shape. The inner frame 12 has a hollow inside provided with a receiving hole 120 to receive the bearing 121.

Each of the buffering members 14 is made of an elastic material and is deformed elastically to provide a buffering effect. Each of the buffering members 14 has an oblong shape and has a hollow inside provided with a buffering space 140. Each of the buffering members 14 has a first side connected with the respective connecting rib 15 and a second side connected with the respective connecting flange 16. Each of the connecting ribs 15 is located opposite to and aligned with a respective one of the connecting flanges 16.

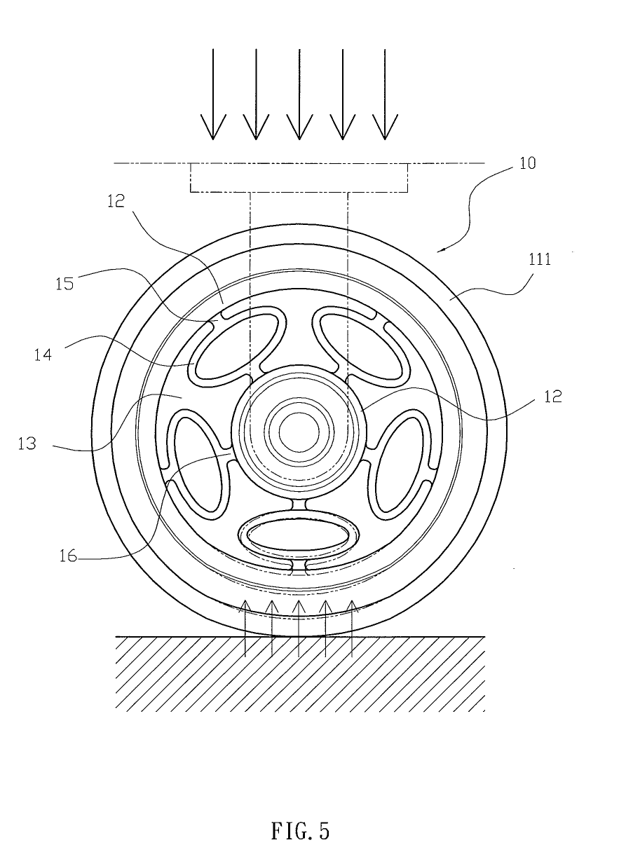

In operation, referring to FIG. 5 with reference to FIGS. 1-4, the buffering members 14 are mounted between the inner frame 12 and the outer frame 11 so that when the castor 10 is subjected to an external force or impact, each of the buffering members 14 is compressed and deformed elastically to provide a buffering effect to the castor 10 so as to achieve a shock absorbing effect.

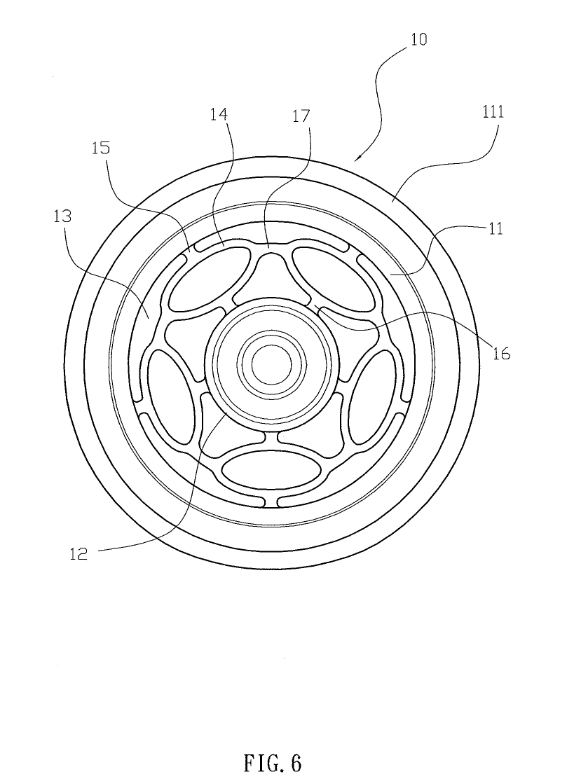

Referring FIG. 6, the castor 10 further comprises a plurality of connecting strips 17 connected between the buffering members 14 so that the buffering members 14 are connected together by the connecting strips 17 to reinforce the structural strength of the castor 10.

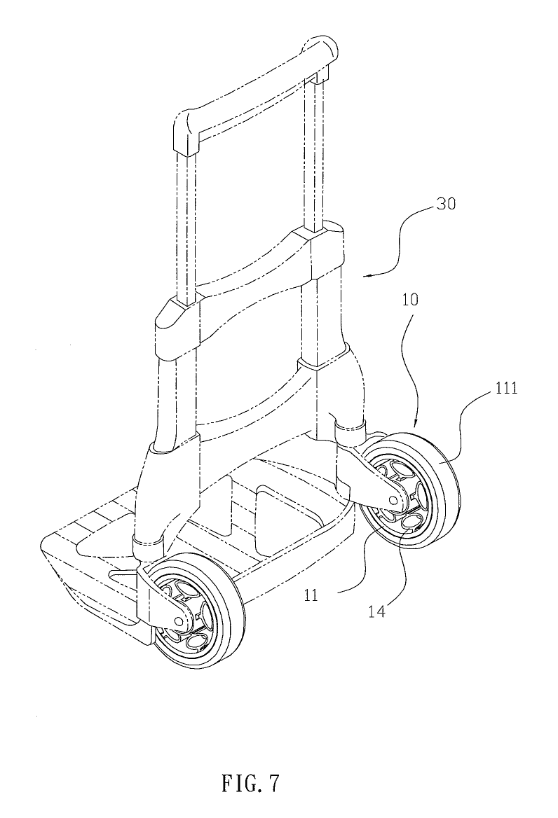

Referring FIG. 7, the castor 10 is available for a hand cart or truck 30.

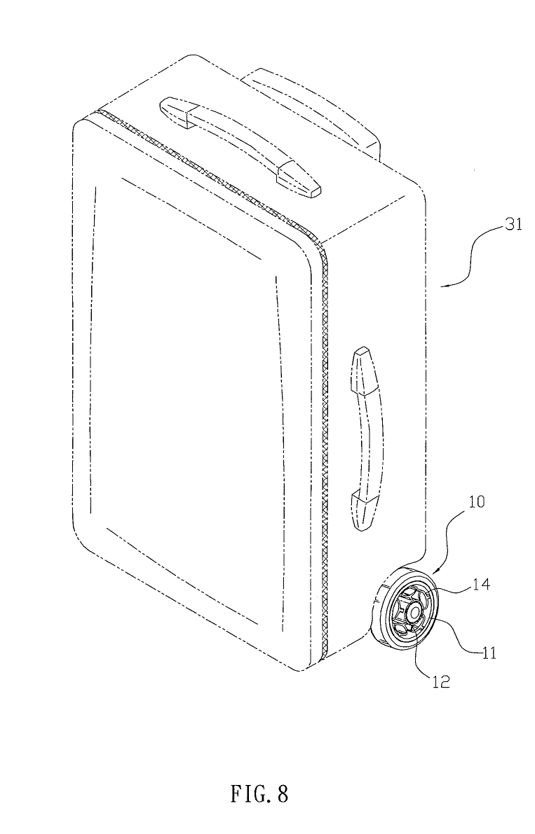

Referring FIG. 8, the castor 10 is available for a luggage carrier 31.

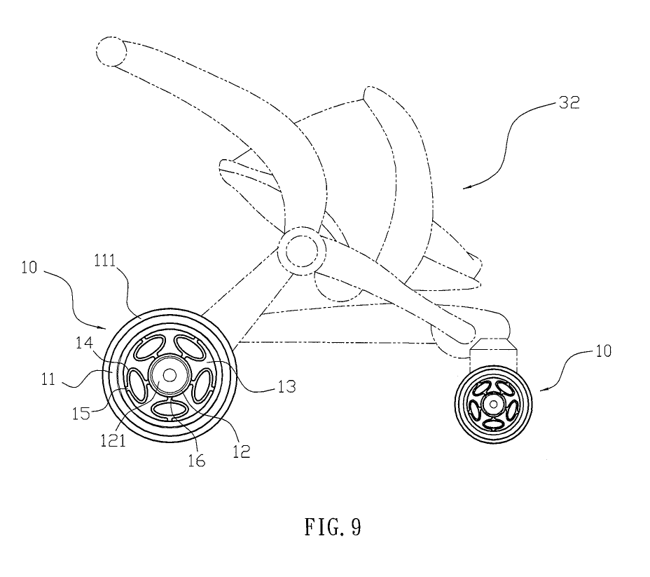

Referring FIG. 9, the castor 10 is available for a baby trolley 32.

Accordingly, the buffering members 14 are mounted between the inner frame 12 and the outer frame 11 and are compressed and deformed elastically to provide a shock absorbing and buffering effect to the castor 10 when the castor 10 is subjected to an external force or impact so as to reduce the vibration and pressure of the castor 10, thereby providing a comfortable sensation to a user when moving the castor 10. In addition, the buffering members 14 provide a shock absorbing effect to the castor 10 so that the castor 10 is moved smoothly without producing noise during movement.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor, comprising:
an inner frame;
an outer frame surrounding the inner frame;
a plurality of buffering members mounted between the inner frame and the outer frame.

2. The castor of claim 1, wherein the castor further comprises:
a plurality of connecting ribs each connected between the outer frame and a respective one of the buffering members;
a plurality of connecting flanges each connected between the inner frame and a respective one of the buffering members.

3. The castor of claim 2, wherein the castor has a receiving chamber defined between the inner frame and the outer frame to receive the buffering members.

4. The castor of claim 3, wherein the receiving chamber has an annular shape.

5. The castor of claim 1, wherein each of the buffering members has an oblong shape.

6. The castor of claim 5, wherein each of the buffering members has a hollow inside provided with a buffering space.

7. The castor of claim 2, wherein each of the buffering members has a first side connected with the respective connecting rib and a second side connected with the respective connecting flange.

8. The castor of claim 7, wherein each of the connecting ribs is located opposite to and aligned with a respective one of the connecting flanges.

9. The castor of claim 2, wherein the castor further comprises:
a plurality of connecting strips connected between the buffering members so that the buffering members are connected together by the connecting strips to reinforce the structural strength of the castor.

10. The castor of claim 1, wherein the castor further comprises:
at least one bearing mounted in the inner frame;
an outer tire mounted on the outer frame.

11. The castor of claim 10, wherein the inner frame has a hollow inside provided with a receiving hole to receive the bearing.

12. The castor of claim 1, wherein each of the buffering members is made of an elastic material and is deformed elastically to provide a buffering effect.
